(19) United States
(12) Patent Application Publication
(10) Pub. No.: US 2006/0132488 A1
(43) Pub. Date: Jun. 22, 2006

(54) Apparatus and method for representing multi-level LOD three-dimensional image

(75) Inventors: Choong Gyo Lim, Daejeon (KR); Won Teak Hwang, Daejeon (KR); Tae Joon Park, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/305,577

(22) Filed: Dec. 16, 2005

(30) Foreign Application Priority Data
Dec. 17, 2004 (KR) 10-2004-0107657
Jul. 8, 2005 (KR) 10-2005-0061731

(51) Int. Cl. G06T 17/00

(52) U.S. Cl. 345/428

(57) ABSTRACT

Provided are an apparatus and a method for representing a multi-level LOD three-dimensional image. The present invention configures a multi-level LOD hierarchical mesh for each hierarchical level with a different LOD level by arranging triangular patches of a upper hierarchical level(lower resolution) to have approximately k×k of triangular patches of an lower hierarchical level (higher resolution) and samples information on height of a target image to allocate the sampled height information to each vertex of the triangular patches included in the multi-level LOD hierarchical mesh, determines an LOD of each triangular patch according to a view point of a virtual camera, and connects the adjacent triangular patches without gaps when adjacent triangular patches among the triangular patches of the multi-level LOD hierarchical mesh have different LOD levels.

### RELATED APPLICATION

The present application is based on, and claims priority from, Korean Application Number 2004-00107657, filed Dec. 17, 2004, and 2005-0061731, filed Jul. 8, 2005 the disclosure of which is hereby incorporated by reference herein in its entirety.

### BACKGROUND OF THE INVENTION

1. Field of the Invention

The present invention relates to a computer graphic system, and more particularly, to an apparatus and a method for representing a three-dimensional model with a vast amount of data such as a large-scale terrain model in a computer system in real time.

2. Description of the Related Art

Recently, a rapid advancement of computer graphic fields such as a virtual reality system and a computer game has led to a development of various methods to represent numerous objects in the real world and terrain in three dimensions. A mesh model has been mainly employed to represent three-dimensional objects of the real world in a computer system. The mesh model particularly represents three-dimensional surfaces of objects or terrain using a collection of a plurality of triangles, tetragons or polygons which are correlated with each other.

For a three-dimensional representation of a vast amount of data such as a large-scale of terrain in a computer system in real time using the mesh model, specific techniques of generating, managing and representing proper terrain are required to effectively utilize limited graphic resources of the computer system. A progressive mesh (PM) based technique, a digital elevation model (DEM) and real-time optimally adaptive meshes (ROAM) are conventional techniques of representing a vast amount of terrain data in real time. These conventional techniques are applied to various fields of computer graphics, virtual reality and a geographical information system (GIS).

In U.S. patent application Ser. No. 6,611,267 issued to A. Migdal et al., entitled “System and Method for Computer Modeling of 3D Objects or Surfaces by Mesh Construction Having Optimal Quality Characteristics and Dynamic Resolution Capabilities,” a three-dimensional modeling method and a system for objects or surfaces using the PM based technique are introduced. The PM based technique configures the mesh model dynamically by determining the order of inserting vertices of polygons within the mesh and gradually inserting the vertices, and thus, the mesh can be always maintained optimally. Also, managing the list including information on the insertion and the removal makes it possible to rapidly remove vertices from the mesh. However, the PM based technique needs to modify the mesh model dynamically to represent three-dimensional images. Hence, the PM based technique generally takes up a large portion of a memory and has a slow data representation rate.

The ROAM technique is discribed in an article by Duchaineau et al., entitled “ROAMing Terrain: Real-Time Optimally Adapting Meshes,” IEEE Visualization on '97 Proceedings, pp. 81-88, 1997. The ROAM technique configures a binary tree of triangls to minimize the reconfiguration of a mesh processed in real time and is optimized by combining a gradual division of the triangle with a deferred list of priority rank calculation. However, the ROAM technique needs to dynamically reconfigure the mesh with various ranges of resolution to represent three-dimensional images. As a result, the ROAM technique may not be proper to a large-scale terrain system, which requires rapid terrain representation.

### SUMMARY OF THE INVENTION

Accordingly, the present invention is directed to an apparatus and a method for representing a multi-level LOD three-dimensional image that substantially obviates one or more problems due to limitations and disadvantages of the related art.

An object of the present invention is to provide an apparatus for reconfiguring a large-scale terrain data in a computer system without taking up a large portion of a memory and a large amount of computation and representing the reconfigured large-scale terrain data, and a method therefor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

According to an aspect of the present invention, there is provided an apparatus for representing a three-dimensional image with a multi-level LOD (level of detail), including: a patch configuration unit configuring a multi-level LOD hierarchical mesh for each hierarchical level with a different LOD level by arranging triangular patches of a higher level (level m+1, lower resolution) to have approximately k×k of triangular patches of an lower level (level m, higher resolution), where k is the number of horizontal and vertical grids at the lower level and sampling information on height of a target image on a regular basis to allocate the sampled height information to each vertex of the triangular patches included in the multi-level LOD hierarchical mesh; an LOD determination unit determining an LOD of each triangular patch according to a view point of a virtual camera; and a patch connection unit connecting the adjacent triangular patches with each other without gaps when the adjacent triangular patches among the triangular patches of the multi-level LOD hierarchical mesh have different LOD levels.

According to an another aspect of the present invention, there is provided a method for representing a three-dimensional image with a multi-level LOD (level of detail), including the steps of: configuring a multi-level LOD hierarchical mesh for each hierarchical level with a different LOD level by arranging triangular patches of a higher level (level m+1, lower resolution) to have approximately k×k of triangular patches of an lower level (level m, higher resolution), where k is the number of horizontal and vertical grids of the lower level; sampling information on height of a target image on a regular basis and allocating the sampled height information to each vertex of the triangular patches included in the multi-level LOD hierarchical mesh; determining an LOD of each triangular patch according to a view point of a virtual camera; and connecting the adjacent triangular patches with each other without gaps when the adjacent triangular patches among the triangular patches of the multi-level LOD hierarchical mesh have different LOD levels.

According to a further aspect of the present invention, there is provided a computer readable recording medium on which a program is used for implementing a method for representing a multi-level LOD three-dimensional image, the computer readable recording medium including: configuring a multi-level LOD hierarchical mesh for each hierarchical level with a different LOD level by arranging triangular patches of a upper level (level m+1, lower resolution) to have approximately k×k of triangular patches of an lower level (level m, higher resolution), where k is the number of horizontal and vertical grids of the upper hierarchical level; sampling information on height of a target image on a regular basis and allocating the sampled height information to each vertex of the triangular patches included in the multi-level LOD hierarchical mesh; determining an LOD of each triangular patch according to a view point of a virtual camera; and connecting the adjacent triangular patches with each other without gaps when the adjacent triangular patches among the triangular patches of the multi-level LOD hierarchical mesh have different LOD levels.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a configuration diagram illustrating an apparatus for representing a multi-level LOD three-dimensional image according to an embodiment of the present invention;

FIG. 2 is a diagram illustrating a hierarchical mesh for representing a multi-level LOD terrain using triangular patches according to an embodiment of the present invention;

FIG. 3 is a diagram illustrating a hierarchical mesh with an n-level hierarchical structure according to an embodiment of the present invention;

FIG. 4 is a diagram illustrating an exemplary arrangement of vertices of the hierarchical mesh with respect to information on height of a regularly sampled target image;

FIG. 5 is a diagram illustrating an exemplary LOD distribution of triangular patches when the LOD is determined based on an error of a screen;

FIG. 6 is a diagram illustrating an exemplary LOD distribution of triangular patches when the LOD is determined based on a distance from a virtual camera;

FIGS. 7(a) to 7(g) are diagrams illustrating a method for connecting adjacent patches having different LOD levels without gaps according to an embodiment of the present invention;

FIGS. 8(a) to 8(d) are diagrams illustrating a method for connecting patches when 2 triangular patches of an higher resolution are arranged adjacent to one selected triangular patch of a lower resolution;

FIG. 9 is a diagram illustrating a multi-level LOD terrain represented based on the screen error based LOD according to an embodiment of the present invention;

FIG. 10 is a flowchart for describing sequential operations of configuring a multi-level LOD hierarchical mesh having different LOD levels using triangular patches according to an embodiment of the present invention; and

FIG. 11 is a flowchart for describing sequential operations of connecting adjacent triangular patches with different LOD levels according to an embodiment of the present invention.

### DETAILED DESCRIPTION OF THE INVENTION

Reference will now be made in detail to the preferred embodiments of the present invention, examples of which are illustrated in the accompanying drawings. It should be noted that like reference numerals denote like elements even in different drawings. When describing the preferred embodiments, detailed description of related known functions or configuration will be omitted if being determined to confuse the main point of the present invention.

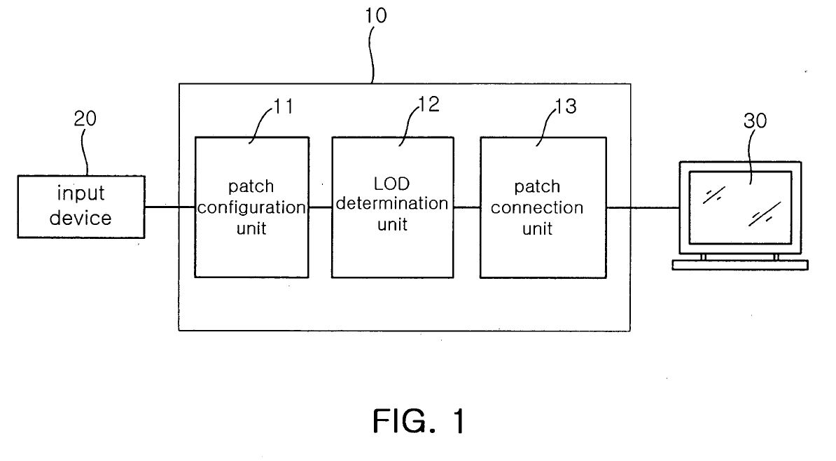

FIG. 1 is a configuration diagram illustrating an apparatus for representing a three-dimensional image with multi-level LOD (level of detail) in accordance with an embodiment of the present invention.

The apparatus 10 includes a patch configuration unit 11, an LOD determination unit 12 and a patch connection unit 13, and is connected to an input device 20 and a display device 30.

The input device 20 provides a target image to be represented on the display device 30 to the apparatus 10. Although the target image is mainly applied with a vast amount of data such as a terrain model, the target image is not limited to the terrain model; rather, the target image can be any images such as objects and surfaces that can be represented three-dimensionally. For instance, in the case of the terrain model, the target image can use scanned images by satellites or air planes, or a terrain model produced by a user.

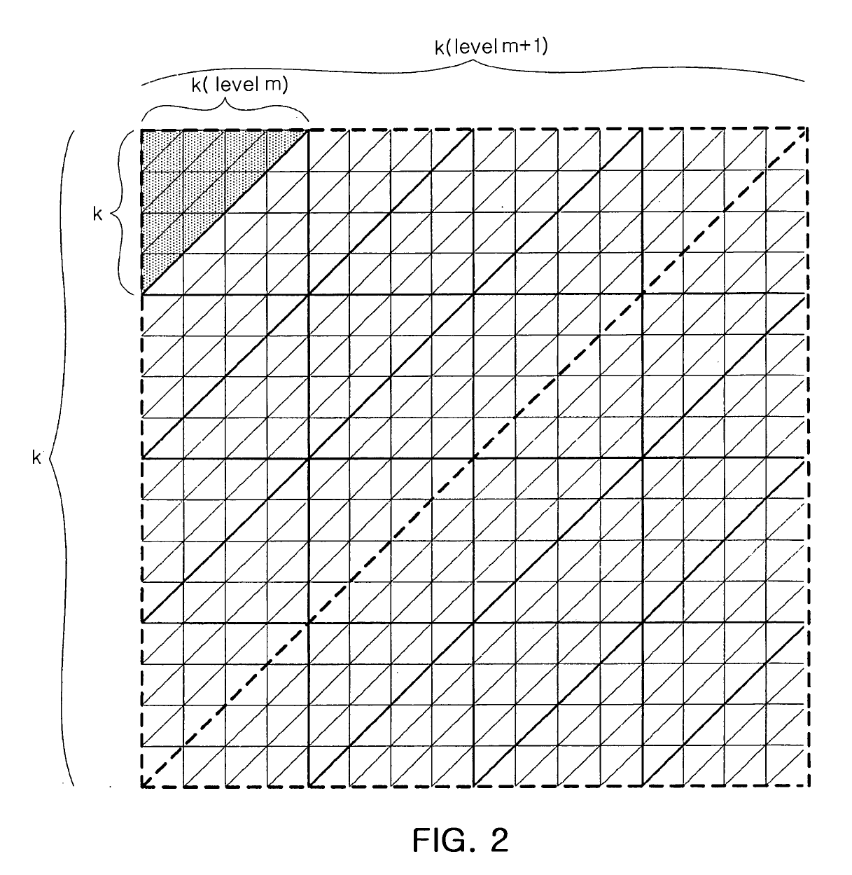

As illustrated in FIG. 2, the patch configuration unit 11, more particularly, triangular patch configuration unit 11 configures a multi-level LOD hierarchical mesh with different LOD levels using triangular patches according to an embodiment of the present invention. Particularly, FIG. 2 is a diagram illustrating a hierarchical mesh for representing multi-level LOD terrain using triangular patches according to the embodiment of the present invention.

The hierarchical mesh is specifically configured to have a multi-level LOD with use of the triangular patches. The hierarchical mesh can be obtained by performing sequential operations of: configuring a two-dimensional square mesh with evenly spaced grids; and dividing each grid in the direction from a top right point of the grid to a bottom left point of the grid to obtain triangular patches constructing isosceles right triangles. The isosceles right triangles denoted with dots configure one patch with the highest LOD. At this point, there are k×k of isosceles right triangles, where k represents the number of vertical and horizontal grids of level m. The k×k number of the patches of level m are collected to configure triangular patches each at the LOD level of m+1. FIG. 2 particularly represents the two-level hierarchical mesh including levels m and m+1. In this case, k is 4. The hierarchical mesh is repeated n times depending on a need of a system, so that an n-level hierarchical mesh including level 1, level 2, . . . , and level n can be configured.

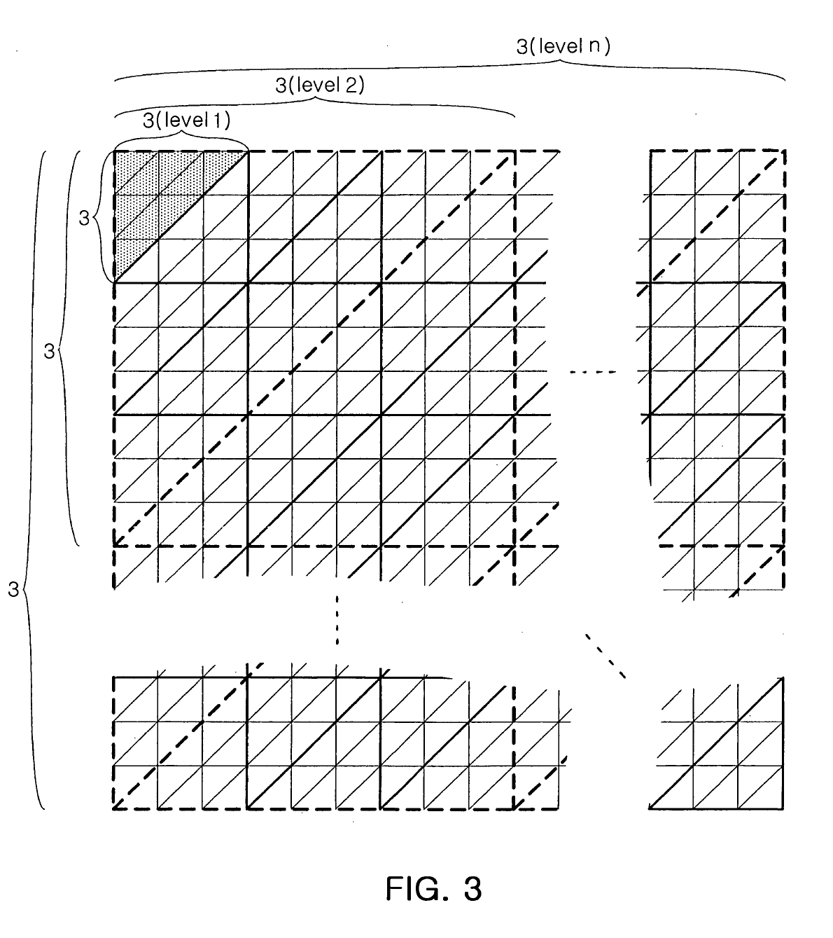

FIG. 3 is a diagram illustrating an n-level hierarchical mesh according to an embodiment of the present invention. In FIG. 3, the number of grids (i.e., k) of triangular patches with the highest LOD is 3, and an n-level hierarchical mesh including the levels 1 to n is illustrated. The number of the grids ‘k’ and the number of levels ‘n’ can be determined depending on a need of a system such as a determined LOD, memory resources and a system speed. The patch that has the highest LOD includes 9 (3×3) of unit triangular patches at the highest level (i.e., level 1). The unit triangular patches are dotted in FIG. 3. Using the 9 triangular patches of level 1, triangular patches of a upper hierarchy that is at level 2 are configured. Using 9 of triangular patches of level n−1, the hierarchical mesh of level n is configured. Therefore, assuming that k is the number of horizontal and vertical grids of an lower level (i.e. level m, higher resolution), level m+1 includes k×k of triangular patches (unit triangular patches) of the lower level are included in triangular patches of the upper hierarchy that is one level higher than the lower hierarchy (i.e. level m).

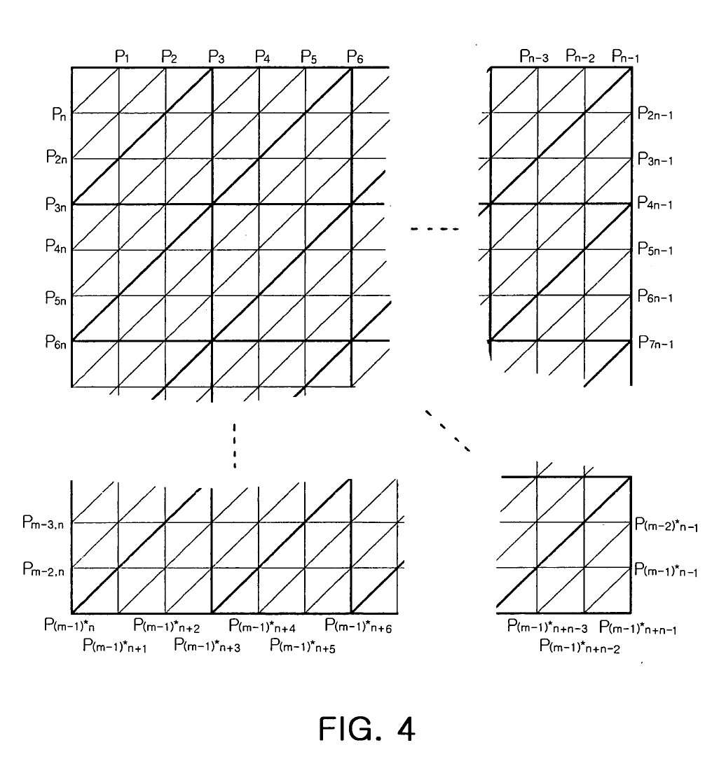

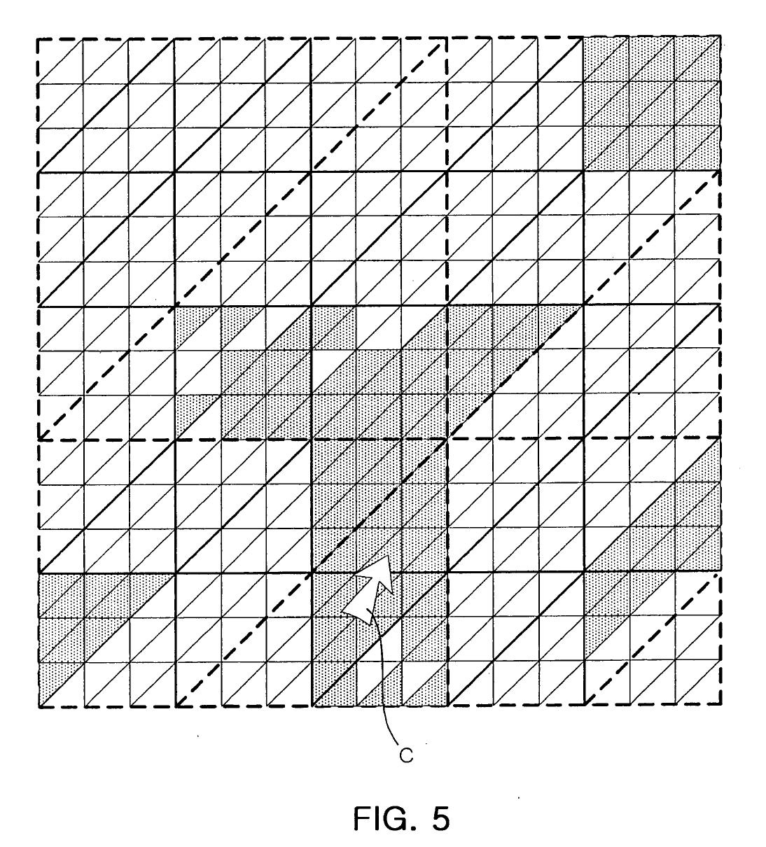

FIG. 5 is a diagram illustrating an exemplary case of arranging each vertex of a hierarchical mesh with respect to regularly sampled pieces of information on height of a target image. The patch configuration unit 11 regularly samples pieces of information on height of a target image inputted from the input device 20, and allocates the pieces of the information to each vertex of the hierarchical mesh obtained according to the embodiment of the present invention. As illustrated in FIG. 4, a specific piece of index information is allocated to each vertex of the individual unit triangles and triangular patches. Therefore, the index information includes the regularly sampled pieces of the information on height of the target image. The LOD determination unit 12 and the patch connection unit 13 are set to be precedently provided with the index information of the vertices of the triangular patches. Hence, even if the triangular patch configuration unit 11 transmits only the index information of each vertex of the hierarchical mesh to the LOD determination unit 12 and the patch connection unit 13, the LOD determination unit 12 and the patch connection unit 13 can determine the information on the height of the target image allocated to vertices of the triangular patches corresponding to the individual pieces of the index information using the received pieces of the index information. The triangular patch configuration unit 11 separately transmits the index information for each vertex to minimize information on polygons transmitted to the LOD determination unit 12 and the patch connection unit 13, and thus, the index information for each vertex can be transmitted without being overlapped. Accordingly, when the indexed hierarchical mesh according to the embodiment of the present invention is used, an amount of data to be transmitted can be minimized and a transmission speed can be increased by approximately 3-fold at maximum in a graphic pipe line supporting indexed polygons.

The LOD determination unit 12 determines an appropriate LOD level according to a view point of a current virtual camera to represent the multi-level target image, which is constructed in precedent processes employing the patch configuration unit 11, on the display device 30 in real time. In the assumption that a virtual character exists within a three-dimensional virtual space constructed in a computer system, the view point of the current virtual camera is a view point of the virtual character seeing the virtual space. As a method for determining the LOD level for the target image according to the view point of the current virtual camera, a method of determining the LOD level according to an error of each triangular patch at a screen and a method of determining the LOD level according to a distance between the vertex of each triangular patch and the virtual camera.

Particularly, the illustrated diagram in FIG. 5 is an exemplary LOD distribution of each triangular patch when the LOD is determined based on the error at the screen (hereinafter referred to as “screen error”). On the basis of the view point of the current virtual camera expressed with a reference denotation C, it is illustrated in FIG. 5 that the LOD of each triangular patch is determined according to the screen error generated when the target image (e.g., terrain) is represented on the screen in large scale or small scale according to a certain ratio. The triangular patches corresponding to dotted regions are set to have a higher LOD level than those triangular patches corresponding to not-dotted regions.

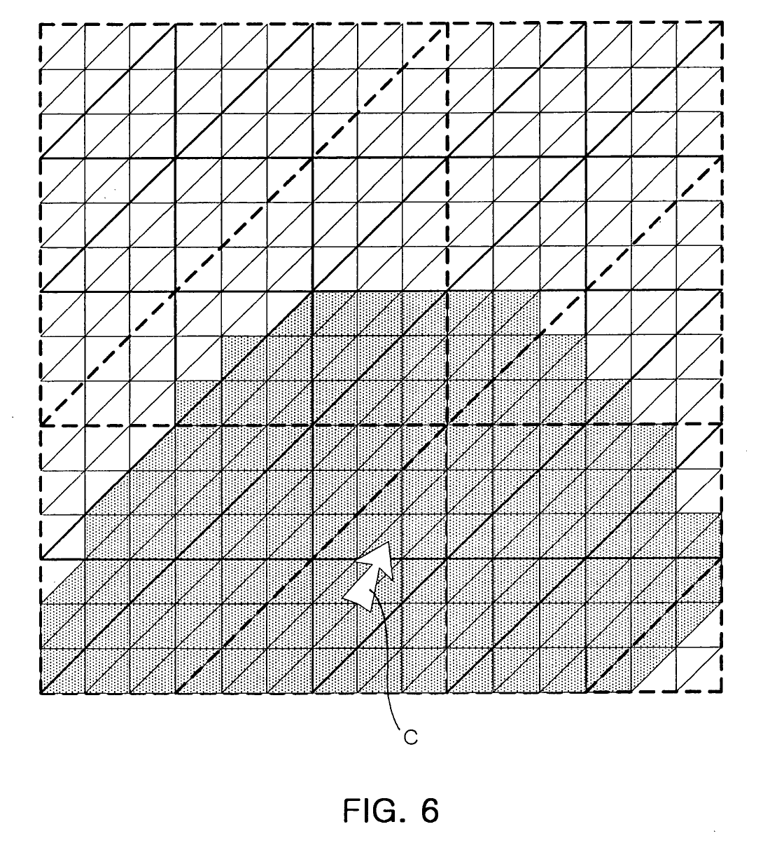

FIG. 6 is a diagram illustrating an exemplary LOD distribution of an individual triangular patch when an LOD level is determined based on a distance with respect to a virtual camera. Particularly, FIG. 6 illustrates the case of determining the LOD level according to a distance of the target image apart from the current virtual camera expressed with a reference denotation C within a virtual space. If the target image is a terrain model, the terrain allocated in a short distance from the virtual camera C, for instance, a mountain is represented with a high LOD level, whereas a background in a long distance is represented with a low LOD level. In FIG. 6, the close areas correspond to a region marked with dots, and the remote areas correspond to a region without dots.

The patch connection unit 13 makes a connection between hierarchically constructed triangular patches with different LOD levels without a gap. The hierarchical mesh according to the present embodiment described in FIG. 3 to FIG. 6 represents a portion of the target image with a higher resolution as a triangular patch of an lower hierarchy (e.g., level n) constructed with a plurality of unit triangular patches, whereas a portion of the target image with a lower resolution as a upper hierarchy (e.g., level n−1) without the unit triangular patches of level n. Therefore, a difference in the size of the triangular patches between hierarchical levels may cause a generation of a gap between the adjacent triangular patches. As a result, the patch connection unit 13 remove the gap by connecting individual vertices existing between the adjacent triangular patches, and thus, it is possible to construct the continuous hierarchical mesh.

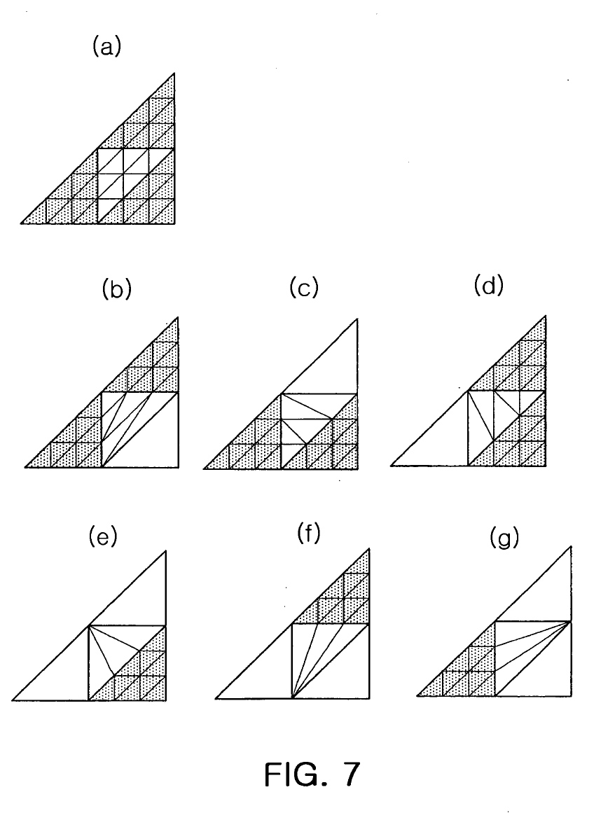

FIGS. 7(a) to 7(g) are diagrams illustrating connection methods for removing gaps generated between adjacent patches with different LOD levels according to an embodiment of the present invention. Those dotted regions in FIGS. 7(a) to 7(g) are one level lower than that of those regions without being dotted.

FIG. 7(a) illustrates an inter-patch connection method when one triangular patch of a lower hierarchical level is surrounded by three triangular patches of an lower hierarchical level (i.e., higher resolution). In this case, vertices of unit triangular patches within the three triangular patches of the lower hierarchical level, being disposed in the boundaries between the triangular patches of the upper hierarchical level and the triangular patch of the lower hierarchical level, are connected with each other, so that the triangular patch of the lower hierarchical level has the same unit triangular patch structure as the triangular patch of the lower hierarchical level. The vertex connection makes it possible to remove gaps between the adjacent triangular patches with different LOD levels.

FIGS. 7(b) to (d) illustrate an inter-patch connection method when two triangular patches of an upper hierarchical level are arranged closely to one triangular patch of a lower hierarchical level. In this case, vertices of unit triangular patches included in the triangular patches of the upper hierarchical level, being disposed in the boundaries between the triangular patches of the upper hierarchical level and the triangular patch of the lower hierarchical level, are connected consecutively in the form of zigzags, so that gaps generated between the adjacent triangular patches with different LOD levels can be removed. For instance, as illustrated in FIG. 7(d), the inter-patch connection method in the case that two triangular patches of the upper hierarchical level are arranged adjacently to one triangular patch of the lower hierarchical level will be described in more detail.

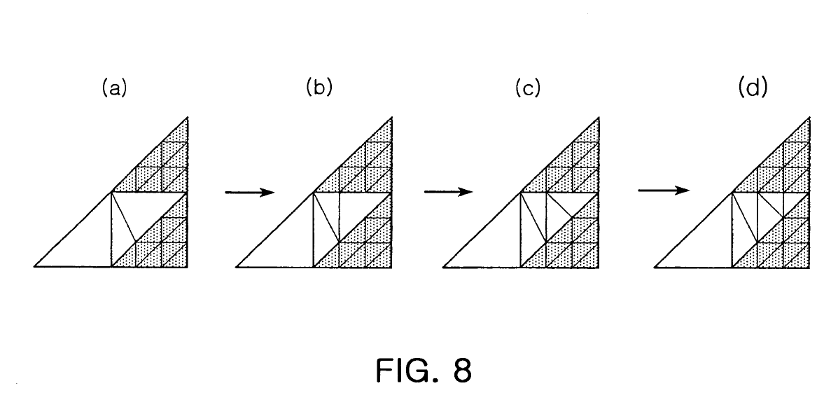

Referring to FIG. 8(a), a in-between vertex of a first triangular patch of an lower hierarchical level(higher resolution) is connected with a in-between vertex allocated most closely to the first vertex among vertices of unit triangular patches of the second triangular patch of the lower hierarchical level allocated in opposite direction to the first triangular patch but facing with each other.

Referring to FIG. 8(b), the second vertex is connected with the third vertex allocated most closely to the second vertex among vertices of unit triangular patches of the first triangular patch allocated in opposite direction to the second triangular patch but facing with each other.

Referring to FIGS. 8 (C) and 8(d), the third vertex is connected with a fourth vertex allocated at a side facing the third vertex among vertices of the unit triangular patches of the second triangular patch, so that gaps between the triangular patches with different LOD levels can be removed.

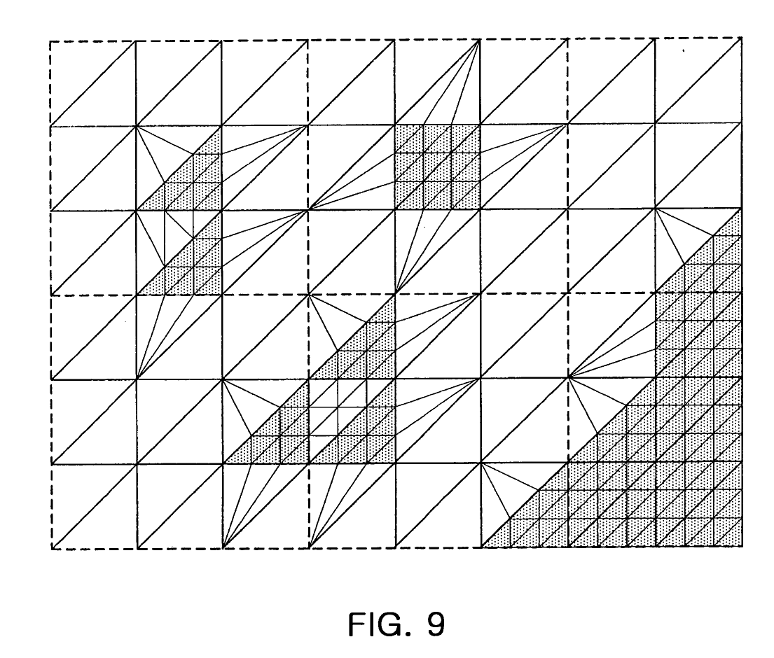

FIG. 9 is a diagram illustrating a multi-level LOD terrain represented based on a screen error based LOD in accordance with an embodiment of the present invention.

The illustrated multi-level LOD terrain is obtained by sequential operations of: determining an LOD based on a screen error using the LOD determination unit 12; and connecting adjacent patches with different LOD levels using the patch connection unit 13 according to the method described in FIGS. 7(a) to 7(g). As described above, the adjacent patches are connected without gaps between them. The final hierarchical mesh configured without gaps according to the present embodiment renders patches with a low LOD level with priority. That is, the rendering activity takes place in the order of the level n, the level n−1, . . . , and the level 1. At this point, the hierarchical levels lower than the patches of the current hierarchical level should not be included in the final hierarchical mesh. For instance, if the current hierarchical level of the rendered patches is m, the patches of less than or equal to level m+1 should not be included in the final hierarchical mesh.

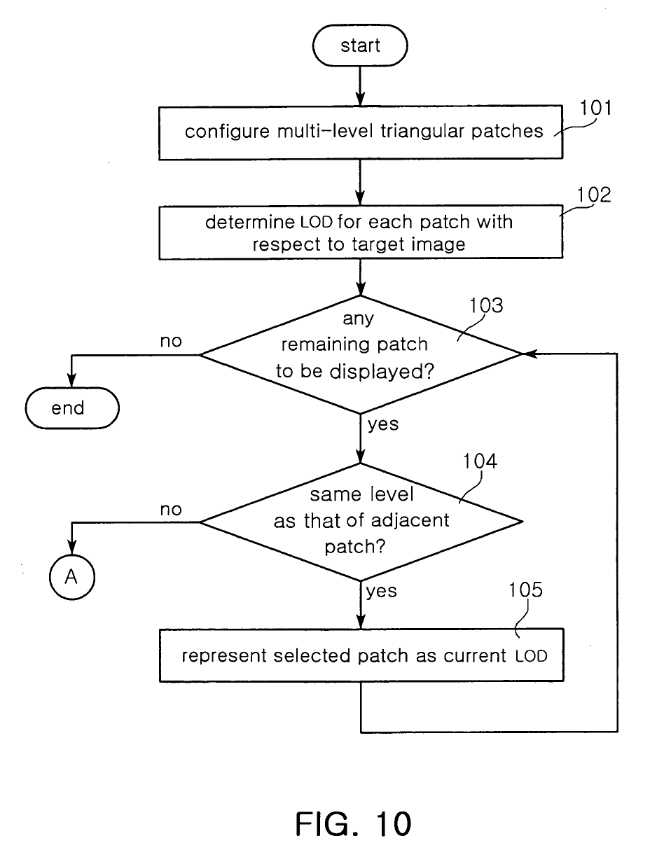

FIG. 10 is a flowchart for describing sequential operations of configuring a multi-level LOD hierarchical mesh with different LOD levels in accordance with an embodiment of the present invention.

In operation 101, using the patch configuration unit 11 of the apparatus 10, triangular patches of a lower hierarchical level (e.g., an level m+1) are configured to include approximately k×k of triangular patches of an upper hierarchical level (e.g., an level m), where k is the number of horizontal and vertical grids of the highest LOD hierarchical level. Each hierarchical level configures the multi-level LOD hierarchical mesh with different LOD levels. The patch configuration unit 11 also regularly samples information on height of a target image such as a terrain model inputted from the input device 20 and allocates the sampled height information to each vertex of the triangular patches of the hierarchical mesh.

In operation 102, an LOD level for each triangular patch of the hierarchical mesh is determined according to a view point of a virtual camera. As described in FIG. 5, the LOD level for each triangular patch of the hierarchical mesh can be determined by an error of the triangular patches displayed on a screen. Also, as described in FIG. 6, the LOD level of each hierarchical level can be determined according to a distance from the virtual camera to each vertex of the triangular patches.

In operation 103, it is determined whether all triangular patches of the hierarchical mesh are represented. If the representation is completed, this operation stage is terminated, and if otherwise, next operation stages proceed.

In operation 104, it is determined whether one triangular patch selected among the several triangular patches of the hierarchical mesh has the same LOD level as the adjacent triangular patch.

In operation 105, if the selected triangular patch has the same LOD level, the triangular patch is represented with a currently set LOD level. If otherwise, an operation stage of ‘A’ proceeds.

The above operation stages from 103 to 105 are repeated for the rest triangular patches until the representation of the hierarchical mesh is completed.

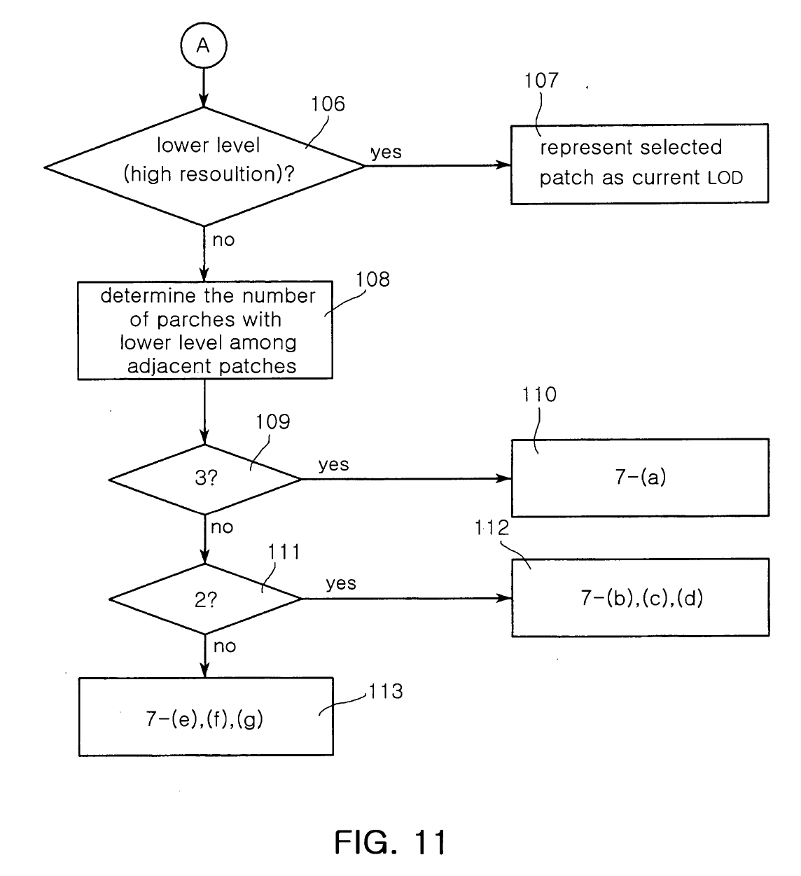

FIG. 11 is a flowchart for describing sequential operations of connecting adjacent triangular patches having different LOD levels without gaps in accordance with an embodiment of the present invention.

The operation stage 106 proceeds when it is determined that the selected triangular patch has a different LOD level from the adjacent triangular patch in operation 104 described in FIG. 10. In operation 106, it is determined whether the selected triangular patch has a lower level (higher resolution) than the adjacent triangular patch.

If the selected triangular patch has a lower level, in operation 107, the selected triangular patch is represented with a currently set LOD level.

If it is determined that the selected triangular patch (corresponding to a patch of a lower hierarchical level) is at the same or upper LOD level in operation 106, the number of the triangular patches having the lower level among the adjacent triangular patches to the selected triangular patch (i.e., the number of patches of the lower hierarchical level) is determined in operation 108.

If it is determined that the number of the patches of the lower hierarchical level is 3 in operation 109, as described in FIG. 7(a), in operation 110, unit triangular patches included in the triangular patches of the lower hierarchical level are connected with each other such that the selected triangular patch of the upper hierarchical level has the same unit triangular patch structure as the triangular patch structure of the lower hierarchical level.

If it is determined that the number of the patches of the lower hierarchical level adjacent to the selected triangular patch of the upper hierarchical level is 2 in operation 111, in operation 112, as described in FIGS. 7(b) to 7(d), vertices of the unit triangular patches within the triangular patches of the lower hierarchical level, which are disposed in the boundaries between the triangular patches of the lower hierarchical level and the triangular patches of the selected upper hierarchical level, are connected consecutively with each other in a zigzag pattern.

If the number of the patches of the lower hierarchical level adjacent to the selected triangular patch of the upper hierarchical level is 1, as described in FIGS. 7(e) to (g), all vertices of the unit triangular patches of the triangular patches within the lower hierarchical level disposed in the boundaries between the triangular patches of the lower hierarchical level and the triangular patches of the upper hierarchical level are connected with vertices of the triangular patches of the upper hierarchical level facing to the boundary line, and as a result, the hierarchical mesh according to the present embodiment can be obtained.

The above described method for representing three-dimensional images with a multi-level LOD using the multi-level LOD hierarchical mesh can be implemented as computer readable codes in a computer readable recording medium. The computer readable recording medium includes various types of recording medium into which data can be read by a computer system are stored. Examples of the computer readable recording medium are ROM, RAM, CD-ROM, magnetic tapes, floppy disks, and optical data storing devices. Also, the computer readable recording medium can include one realized in the form of a carrier wave such as transmission through Internet. Also, codes which can be read by the computer based on a distribution mode are stored into the computer readable recording medium distributed within a computer system connected via a network and can also be executed.

According to the exemplary embodiments of the present invention, the multi-level LOD hierarchical mesh is configured using the triangular patches. Particularly, a mesh of a target image such as terrain is configured using information on height allocated to each vertex of the triangular patches included in the hierarchical mesh, and thus, usage of memory resources of a computer system can be reduced by approximately 3-fold.

Also, different from the conventional PM based method of dynamically generating vertices of the mesh, the multi-level LOD hierarchical mesh is configured in advance, and pieces of information on indices of vertices of the triangular patches for the hierarchical mesh are arranged separately. As a result, patches with various LOD levels can be produced and represented in real time.

In addition to the precedent configuration of the multi-level LOD hierarchical mesh and determination of the LOD of each patch using the index information for the vertices of the triangular patches used in the multi-level LOD hierarchical mesh configuration, connecting the triangular patches with different LOD levels without gaps can reduce usage of computation resources used for merging or separating the triangular patches.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for representing a three-dimensional image with a multi-level LOD (level of detail), comprising:
a patch configuration unit configuring a multi-level LOD hierarchical mesh for each hierarchical level with a different LOD level by arranging triangular patches of a upper hierarchical level (level m+1, lower resolution) to have approximately k×k of triangular patches of an lower hierarchical level (level m, higher resolution), where k is the number of horizontal and vertical grids of the lower hierarchical level and sampling information on height of a target image on a regular basis to allocate the sampled height information to each vertex of the triangular patches included in the multi-level LOD hierarchical mesh;
an LOD determination unit determining an LOD of each triangular patch according to a view point of a virtual camera; and
a patch connection unit connecting the adjacent triangular patches with each other without gaps when the adjacent triangular patches among the triangular patches of the multi-level LOD hierarchical mesh have different LOD levels.

2. The apparatus of claim 1, wherein the LOD level of the upper hierarchical level is lower than that of the lower hierarchical level.

3. The apparatus of claim 1, wherein the triangular patches are obtained by dividing the respective grids in the direction from a top right vertex to a bottom left vertex.

4. The apparatus of claim 1, wherein the triangular patches are right-angled triangles.

5. The apparatus of claim 1, wherein if 3 of the triangular patches of the lower hierarchical level are arranged adjacent to the triangular patches of the upper hierarchical level, vertices of unit triangular patches existing within the triangular patches of the lower hierarchical level are connected such that the triangular patches of the upper hierarchical level have the same unit triangular patch structure as that of the triangular patches of the lower hierarchical level.

6. The apparatus of claim 1, wherein if 2 of the triangular patches of the lower hierarchical level are arranged adjacent to the triangular patches of the upper hierarchical level, vertices of unit triangular patches included in the triangular patches of the lower hierarchical level disposed in the boundaries between the triangular patches of the lower hierarchical level and the triangular patches of the upper hierarchical level are consecutively connected with each other in a zigzag pattern.

7. The apparatus of claim 1, wherein if 1 of the triangular patches of the lower hierarchical level is arranged adjacent to the triangular patches of the upper hierarchical level, vertices of unit triangular patches included in the triangular patches of the lower hierarchical level disposed in the boundary between the triangular patches of the lower hierarchical level and the triangular patches of the upper hierarchical level are connected with vertices of the triangular patches included in the lower hierarchical level facing the boundary line in apposite direction.

8. The apparatus of claim 1, wherein the patch configuration unit transmits information on indices of vertices of the triangular patches to the LOD determination unit or the patch connection unit, and the LOD determination unit or the patch connection unit determines the information on the height of the target image using the information on the indices.

9. A method for representing a three-dimensional image with a multi-level LOD (level of detail), comprising the steps of:
configuring a multi-level LOD hierarchical mesh for each hierarchical level with a different LOD level by arranging triangular patches of a upper hierarchical level (level m+1, lower resolution) to have approximately k×k of triangular patches of an lower hierarchical level (level m, higher resolution), where k is the number of horizontal and vertical grids of the lower hierarchical level;
sampling information on height of a target image on a regular basis and allocating the sampled height information to each vertex of the triangular patches included in the multi-level LOD hierarchical mesh;
determining an LOD of each triangular patch according to a view point of a virtual camera; and
connecting the adjacent triangular patches with each other without gaps when the adjacent triangular patches among the triangular patches of the multi-level LOD hierarchical mesh have different LOD levels.

10. The method of claim 9, wherein at the step of configuring the multi-level LOD hierarchical mesh, the LOD level of the lower hierarchical level is higher than that of the lower hierarchical level.

11. The method of claim 9, wherein the triangular patches are obtained by dividing the respective grids in the direction from a top right vertex to a bottom left vertex.

12. The method of claim 9, wherein the triangular patches are right-angled triangles.

13. The method of claim 9, wherein at the step of connecting the adjacent triangular patches without gaps, if 3 of the triangular patches of the lower hierarchical level are arranged adjacent to the triangular patches of the upper hierarchical level, vertices of unit triangular patches existing within the triangular patches of the lower hierarchical level are connected such that the triangular patches of the upper hierarchical level have the same unit triangular patch structure as that of the triangular patches of the lower hierarchical level.

14. The method of claim 9, wherein at the step of connecting the adjacent triangular patches without gaps, if 2 of the triangular patches of the lower hierarchical level are arranged adjacent to the triangular patches of the upper hierarchical level, vertices of unit triangular patches included in the triangular patches of the lower hierarchical level disposed in the boundaries between the triangular patches of the lower hierarchical level and the triangular patches of the upper hierarchical level are consecutively connected with each other in a zigzag pattern.

15. The method of claim 9, wherein at the step of connecting the adjacent triangular patches without gaps, if 1 of the triangular patches of the lower hierarchical level is arranged adjacent to the triangular patches of the upper hierarchical level, vertices of unit triangular patches included in the triangular patches of the lower hierarchical level disposed in the boundary between the triangular patches of the lower hierarchical level and the triangular patches of the upper hierarchical level are connected with vertices of the triangular patches included in the lower hierarchical level facing the boundary line in apposite direction.
